(19) United States
(12) Patent Application Publication
(10) Pub. No.: US 2009/0148697 A1
(43) Pub. Date: Jun. 11, 2009

(54) ELECTROPHOTOGRAPHIC RECORDING MEDIUM

(75) Inventor: Taek-yong JUNG, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/252,445

(22) Filed: Oct. 16, 2008

(30) Foreign Application Priority Data
Dec. 10, 2007 (KR) 2007-127572

(51) Int. Cl. B32B 9/04; B32B 21/04; C09J 7/02; C08K 3/24; B32B 29/00

(52) U.S. Cl. 428/337; 428/537.1; 428/537.5; 428/447; 524/405

(57) ABSTRACT

An electrophotographic recording medium includes a base and a toner fixation layer, wherein the toner fixation layer includes a filler, a binder, and a surface hardener. The electrophotographic recording medium can have superior toner fixability, high printing gloss, and high printing quality.

### CROSS-REFERENCE TO RELATED APPLICATIONS

This application claims priority under 35 U.S.C. §119(a) from Korean Patent Application No. 10-2007-0127572, filed on Dec. 10, 2007, in the Korean Intellectual Property Office, the disclosure of which is incorporated herein in its entirety by reference.

### BACKGROUND OF THE INVENTION

1. Field of the Invention

The present general inventive concept relates to an electrophotographic recording medium, and more particularly, to an electrophotographic recording medium which has excellent smoothness and gloss properties, and has high printing gloss and printing quality due to excellent toner fixability in electrophotographic printers.

2. Description of the Related Art

As an amount and variety of computer applications have increased, various types of documents and images are produced using computers and printed out using printers. Such printers include dot impact printers, laser printers, thermal printers, inkjet printers, and the like. Among these printers, laser printers that use a laser beam printing method (electrophotography) are widely used by general consumers in addition to inkjet printers due to high printing speeds and an ability of the inkjet printers to print high-resolution images.

Electrophotography applied to printers or copiers has generally five imaging processing operations. First, a photoconductive drum or belt is constantly charged in a dark place. Second, laser beams are irradiated to the photoconductive drum or belt to form electrostatic latent images. Third, the electrostatic latent images are exposed to charge toner to fix the toner on the electrostatic latent images by electrostatic force. Fourth, a recording medium is passed between the photoconductive drum or belt and a corona to transfer the toner to the recording medium. Herein, the recording medium must be conductive to some extent in order to transfer toner images thereto by electrostatic force. Fifth, the transferred toner is fixed on the recording medium by hot fusing in which heat and pressure are applied to the recording medium mainly using a roller.

In such electrophotographic printers, a variety of recording media in addition to general paper are used. As characteristics of toner used in electrophotographic printers are improved and transfer and fixation technologies are advanced, professional recording media such as high gloss recording media that are commonly used in inkjet printers are required even in electrophotographic printers.

Professional paper used in electrophotographic printers generally includes a toner fixation layer coated on one surface of a base. The toner fixation layer is prepared by mixing a pigment and a binder in a predetermined amount and coating the mixture on the base. After the mixture is coated on the base, the resulting structure can be calendared to obtain smooth surfaces and gloss properties. Conventionally, professional paper has good smoothness and gloss properties by using an inorganic pigment having a small particle diameter or by enhancing calendaring conditions. The smoothness and gloss properties of the professional paper affect printing gloss during printing, and thus the smoothness and gloss properties of paper play a critical role in improving printing quality. However, paper including an inorganic pigment having a small particle diameter is expensive, and due to the small particle diameter, handling and processing the inorganic pigment is difficult. In the case of paper using an inorganic pigment having a large particle size, calendaring should be necessarily performed. In general, calendaring diversifies a thickness, smoothness and gloss properties of paper by adjusting temperature and pressure conditions. In addition, the higher the temperature and pressure, the less the thickness of the paper, and the better the smoothness and gloss properties. However, excessive temperature and pressure may result in a lot of problems in paper manufacturing. In addition, if the base is in a poor condition, properties of the base affect the toner fixation layer, and thus the lowest possible values of temperature and pressure are required.

Therefore, there is still a need to develop paper with high printing quality, which can be used in electrophotographic printers.

### SUMMARY OF THE INVENTION

The present general inventive concept provides an electrophotographic recording medium having excellent toner fixability, and having improved printing gloss properties and printing quality.

The present general inventive concept also provides a composition to form a toner fixation layer included in the electrophotographic recording medium.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by providing an electrophotographic recording medium including a base and a toner fixation layer formed on at least one surface of the base, wherein the toner fixation layer includes a filler, a binder, and a surface hardener.

The foregoing and/or other aspects and utilities of the general inventive concept may also be achieved by providing an electrophotographic recording medium including a base and a toner fixation layer formed on at least one surface of the base, wherein the toner fixation layer includes an inorganic filler and a binder, wherein the inorganic filler includes at least two materials each having a volume average particle diameter different from each other.

The foregoing and/or other aspects and utilities of the general inventive concept may also be achieved by providing a composition to form a toner fixation layer, the composition including a filler, a binder, and a surface hardener.

The foregoing and/or other aspects and utilities of the general inventive concept may also be achieved by providing an electrophotographic recording medium including a base having an upper surface and a lower surface opposite each other, and a toner fixation layer formed on the upper surface and the lower surface, wherein the toner fixation layer includes a filler, a binder, an additive and a surface hardener.

### BRIEF DESCRIPTION OF THE DRAWINGS

The above and other features and utilities of the present general inventive concept will become more apparent by describing in detail exemplary embodiments thereof with reference to the attached drawings in which:

FIG. 1 is a cross-sectional view illustrating a laminated structure of an electrophotographic recording medium according to an embodiment of the present general inventive concept; and

FIG. 2 is a cross-sectional view illustrating a laminated structure of an electrophotographic recording medium according to another embodiment of the present general inventive concept.

### DETAILED DESCRIPTION OF THE PREFERRED EMBODIMENTS

Hereinafter, the present general inventive concept will be described more fully with reference to the accompanying drawings.

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

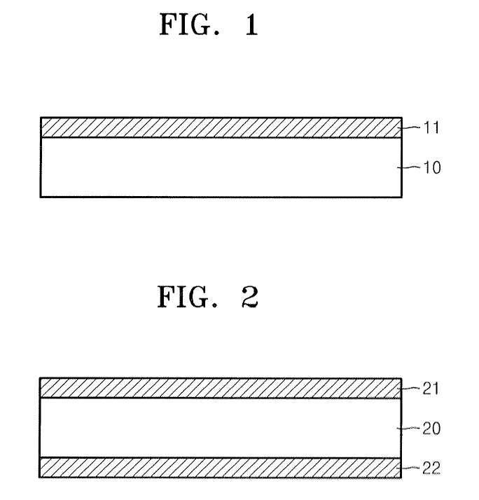

The present general inventive concept provides an electrophotographic recording medium including a base and a toner fixation layer. FIG. 1 is a cross-sectional view illustrating a laminated structure of an electrophotographic recording medium according to an embodiment of the present general inventive concept. Referring to FIG. 1, the electrophotographic recording medium according to the current embodiment includes a toner fixation layer 11 formed on a surface of a base 10. FIG. 2 is a cross-sectional view illustrating a laminated structure of an electrophotographic recording medium according to another embodiment of the present general inventive concept. Referring to FIG. 2, the electrophotographic recording medium according to the current embodiment includes toner fixation layers 21 and 22 respectively formed on both surfaces of a base 20. According to an embodiment of the present general inventive concept, each of the toner fixation layers 11, 21 and 22 may include a filler, a binder, and a surface hardener. In addition, each of the toner fixation layers 11, 21 and 22 may include a filler and a binder, wherein the filler may include at least two materials each having a volume average particle diameter different from each other.

The base used in the electrophotographic recording medium according to the present general inventive concept may be any base used in a recoding medium in the art without limitation, and is not particularly limited. Therefore, the base may include any material which can endure a fixing temperature and satisfy requirements such as smoothness, whiteness, friction, antistatic property, fixability, and the like, according to the purpose of the use. In particular, the base may include mixed paper prepared from a natural pulp and a synthetic resin pulp such as synthetic paper (for example, polyolefins, polystyrenes, or the like), woodfree paper, art paper, coated paper, polyethylene, or the like, baryta paper, a synthetic resin, impregnated paper such as emulsion impregnated paper or synthetic rubber latex impregnated paper, or a paper support such as paperboard, cellulose tissue paper, or the like. In addition, the base may include a plastic film support such as polyolefin, polyvinyl chloride, polyethylene terephthalate, polystyrene, polymethacrylate, polycarbonate, or the like. Further, the base may include a white opaque film prepared by adding a white pigment or a filler to the synthetic paper, a foamed sheet prepared by foaming the synthetic paper, or the like. The base may include a single-layered structure, or include a combination of two or more layers, that is, in the form of a laminated structure, for example, a laminated structure of cellulose tissue paper and synthetic paper, or a laminated structure of cellulose tissue paper and a plastic film.

The thickness of the base can be set according to the purpose of the use of the electrophotographic recording medium. The thickness of the base is generally in a range of 50 to 300 μm, and may be in a range of 70 to 200 μm. If the thickness of the base is less than 50 μm, the electrophotographic recording medium may be bent after printing; alternatively, if the thickness of the base is greater than 300 μm, the electrophotographic recording medium cannot be properly supplied to a printer.

To improve adhesion between the base and the toner fixation layer formed on a surface of the base, the surface of the base may be treated with primer, corona discharge, or the like, if necessary.

The toner fixation layer may be formed of known components used in a conventional recording medium. Main components of the toner fixation layer may be a filler and a binder. The filler may be an inorganic filler or an organic filler.

The inorganic filler may be kaolin clay, silica, calcium carbonate, talc, aluminum hydroxide, satin white, titanium dioxide, calcined clay, zinc oxide, barium sulfate, or the like. The organic filler may be a styrene-based resin such as polystyrene, polymethylstyrene, or the like; an acryl-based resin such as polymethacrylic acid methyl, polyacrylonitrile, or the like; polyvinyl chloride, polycarbonate, or the like, or may be mixtures thereof mixed in a certain ratio.

A volume average particle diameter of the filler may be in a range of 0.05 to 2.0 μm, such as in a range of 0.1 to 2.0 μm. When the volume average particle diameter of the filler is less than 0.05 μm, costs increase and handling dust is difficult when a composition including the filler is prepared. Alternatively, when the volume average particle diameter of the filler is greater than 2.0 μm, high temperature and pressure are required during calendering.

The binder may be at least one selected from the group consisting of polyvinyl alcohol, polyvinyl pyrolidone, methyl cellulose, hydroxypropylmethyl cellulose, gelatin, polyethylene oxide, an acryl-based polymer, polyester, polyurethane, an epoxy resin, latex, and a quaternary ammonium-based copolymer.

The latex, for example, may be a styrene-butadiene latex, a styrene-butadiene-acrylonitrile latex, an acryl-based latex, or the like.

An amount of the binder may be in a range of 5 to 100 parts by weight, such as in a range of 10 to 75 parts by weight, based on 100 parts by weight of the filler included in the toner fixation layer. When the amount of the binder is less than 5 parts by weight based on 100 parts by weight of the filler included in the toner fixation layer, the adhesion between the toner fixation layer and the base is degraded; alternatively, when the amount of the binder is greater than 100 parts by weight based on 100 parts by weight of the filler included in the toner fixation layer, paper feeding problems during printing, such as paper jams, multi-feeding of paper, and the like occur.

According to an embodiment of the present general inventive concept, the toner fixation layer may include a surface hardener.

To enhance resistance to environments of ink ejected onto inkjet photographic paper, in particular, water resistance, the toner fixation layer includes a surface hardener such as a curing agent, or the like. However, toner used in electrophotographic printers includes a pigment, and thus there is no problem with the water resistance of the toner, unlike ink for an inkjet printer, which uses dyes. Thus, the toner fixation layer basically does not need to include a surface hardener.

However, according to an embodiment of the present general inventive concept, the surface hardener is not used to enhance water resistance, but used to harden the surface of the electrophotographic recording medium by being included in the toner fixation layer.

That is, when the surface of the electrophotographic recording medium is hard, calendaring efficiency increases under a predetermined temperature and pressure during calendaring, compared to when the electrophotographic recording medium has a weak surface. That is, the electrophotographic recording medium has a hard surface by including a soft pigment and a hard binder, wherein the amount of the binder is greater than that of the pigment. When a surface of the electrophotographic recording medium is too soft, base properties are exhibited to the surface of the electrophotographic recording medium when a constant pressure is applied to the surface of the electrophotographic recording medium at a constant temperature, and thus relatively high values of temperature and pressure can not be used. However, when the surface of the electrophotographic recording medium is hard, ranges of temperature and pressure are extended, and thus desired smoothness and gloss properties can be obtained.

The surface hardener can be any chemical that can be used to harden the surface of paper in the art. Non-restrictive examples of the surface hardener include a water-soluble curing agent, a siloxane-based surfactant, a silane coupling agent, and the like.

The water-soluble curing agent may be boric acid, glyoxal, aziridine, or the like. The silane coupling agent may be vinyltrimethoxysilane, vinyltriethoxysilane, γ-chloropropyltrimethoxysilane, N-β-(aminoethyl)-γ-aminopropylmethyldimethoxysilane, N-β-(aminoethyl)-γ-aminopropyltrimethoxysilane, γ-glycidoxypropyltrimethoxysilane, γ-mercaptopropyltrimethoxysilane, 3-glycidoxypropyltrimethoxysilane, or the like. The siloxane-based surfactant may be organic polysiloxane dimethicone polyol, silicone carbinol fluid, silicone polyether, alkylmethyl siloxane, amodimethicone, trisiloxane ethoxylate, dimethiconol, quaternized silicone surfactant, polysilicone, silicone crosslinked polymer, silicone wax, or the like; however, the present general inventive concept is not limited thereto.

An amount of the surface hardener may be in a range of 0.1 to 5 parts by weight, such as in a range of 0.5 to 3 parts by weight, based on 100 parts by weight of the filler. When the amount of the surface hardener is less than 0.1 parts by weight based on 100 parts by weight of the filler, an effect of addition of the surface hardener is insignificant. Alternatively, when the amount of the surface hardener is greater than 5 parts by weight based on 100 parts by weight of the filler, the surface of the toner fixation layer is too hard, and thus the toner fixation layer can be easily broken.

According to an embodiment of the present general inventive concept, the toner fixation layer may further include any additives which improve the stability of printed images or the toner fixation layer, improve processability of the electrophotographic recording medium, and the like. Such additives may include an antistatic agent, a cross-linking agent, a dye, a light diffusing agent, a pH adjuster, an antioxidant, an antifoaming agent and deaerator, a leveler, a lubricant, an anticurling agent, a thickener, a degradation inhibitor, an ozone degradation inhibitor, an antiseptic, and the like, which are known in the art.

In an electrophotographic printing method such as a laser beam printing method, toner is charged and attached to printing paper using the charge, and thus an electroconductivity of the paper highly affects an accurate image formation. Electroconductivity may represent surface resistance of a coated layer. Generally, surface resistance is used instead of electroconductivity, and thus the term “surface resistance” is used herein together with the term “electroconductivity.” Therefore, as components constituting the base and toner fixation layer, an electroconductive polymer or additives, for example, an antistatic agent, and the like can be added in order to provide electrical conductivity. The antistatic agent, which is an additive used to provide conductivity may be an inorganic dye such as sodium chloride, potassium chloride, or the like, a polyhydric alcohol such as glycerine, propyleneglycol, ethyleneglycol, polyethyleneglycol, trimethyleneglycol, sobitol, or the like, a quaternary ammonium salt, or the like. The respective antistatic agents provide conductivity, thereby having an antistatic function, and solve problems caused by continuous paper feeding due to static electricity generation. Thus, the term “antistatic agent” is used instead of a conducting agent.

When an electroconductive polymer or an antistatic agent is used to form the base or toner fixation layer, it is preferable that the surface resistance of the toner fixation layer may be maintained in a range of 10⁹ to 10¹⁴Ω (measured at 20° C. and a relative humidity of 20%). This surface resistance is suitable for fixation of toner and to prevent scatter of toner. In a conventional recording medium, surface resistance is adjusted by using the anti-static agent, such as an inorganic dye, for example, sodium chloride, potassium chloride, or the like, a quaternary ammonium salt, or the like. However, controlling the surface resistance in a certain range using the respective components under varying temperature and humidity conditions is difficult. For example, the surface resistance at a high temperature and a high humidity, for example, at 32° C. and a relative humidity of 90%, may be reduced, thus causing poor transferring of toner.

The total amount of the additives included in the toner fixation layer may be in a range of 0.1 to 10 parts by weight, such as in a range of 0.1 to 5 parts by weight, based on 100 parts by weight of the filler. When the total amount of the additives is less than 0.1 parts by weight based on 100 parts by weight of the filler, an effect of addition of the additives is insignificant. Alternatively, when the total amount of the additives is greater than 10 parts by weight based on 100 parts by weight of the filler, printed images are degraded, and coating of toner can not be fully performed.

The electrophotographic recording medium according to the present general inventive concept may further include an outermost layer formed on the toner fixation layer, wherein the outermost layer is formed in a single layer form. To provide mainly gloss properties, the outermost layer includes a smaller amount of the filler than that of the filler included in the toner fixation layer, or includes an organic pigment as the filler, that is, a plastic pigment, and thereby an effect of adding the filler can be obtained. In addition, an outermost layer can be formed as a resin layer formed primarily of the binder.

According to an embodiment of the present general inventive concept, the toner fixation layer of the electrophotographic recording medium may be formed by coating a composition to form a toner fixation layer as a coating solution on a base and drying the coating solution.

The composition to form a toner fixation layer includes a filler, a binder, and a surface hardener. In particular, the amounts of the binder and the surface hardener may be respectively in a range of 5 to 100 parts by weight and in a range of 0.1 to 10 parts by weight based on 100 parts by weight of the filler. Descriptions of the filler, binder and surface hardener are the same as described above.

The solvent used in the composition to form a toner fixation layer is not particularly limited, but may be water, taking into consideration environmental problems, work efficiencies, and the like. The solvent may be, in addition to water, selected from the group consisting of ketones, glycol ethers, alcohols, methylcellosolve, ethylcellosolve, dimethyl formamide, and dimethyl sulfoxide. In particular, the ketones may be acetone and methyl ethyl ketone, the glycol ethers may be diethylene glycol and diethylene glycol monobutyl ether, and the alcohols may be methanol, ethanol, butanol, isopropanol, and the like.

The amount of the solvent is adjusted such that an amount of the solid of the composition to form a toner fixation layer may be in a range of 5 to 80 wt %, such as in a range of 20 to 70 wt %, based on 100 wt % of the solvent. When the amount of the solid of the composition to form a toner fixation layer is less than 5 wt % based on 100 wt % of the solvent, the composition to form the toner fixation layer can not be dried when being coated. Alternatively, when the amount of the solid of the composition to form a toner fixation layer is greater than 80 wt % based on 100 wt % of the solvent, a viscosity of the composition is too high and thus cracks may occur or unwanted defects may be generated, resulting in poor coated surface properties.

In the electrophotographic recording medium according to the present general inventive concept, the toner fixation layer is prepared by coating the composition to form a toner fixation layer on one or both surface of the base and drying the composition, as described above. The coating process may be performed by blade coating, roll coating, or knife coating. The drying process may be performed at a temperature in a range of 50 to 130° C. for 2 seconds to 5 minutes. In this process, when a cross-linking agent is included in the composition to form the toner fixation layer, a thermal cross-linking reaction occurs due to the cross-linking agent. Therefore, when the drying temperature is less than 50° C., cross-linking reactivity is deteriorated. Alternatively, when the drying temperature is greater than 130° C., yellowing may occur.

A thickness of the toner fixation layer prepared in the process described above may be in a range of about 5 to about 40 μm, such as in a range of 10 to 30 μm. When the thickness of the toner fixation layer is less than 5 μm, the toner fixation layer can not function properly. Alternatively, when the thickness of the toner fixation layer is greater than 40 μm, raw material costs are high and the composition to form the toner fixation layer can not be dried when being coated.

After the coating and drying of the composition to form the toner fixation layer, calendaring is performed using calendar devices such as machine calendars, TG calendars, soft calendars, or super calendars by an on-machine method (a coating method during papermaking in a drying unit of a paper machine) or an off-machine method (a method of coating paper made by a paper machine using a separate coater) in order to improve smoothness and gloss properties.

The electrophotographic recording medium according to the present general inventive concept can be usefully applied in any type of printing devices, for example, laser printers, facsimiles, copiers, and the like.

According to an embodiment of the present general inventive concept, an electrophotographic recording medium including a base and a toner fixation layer formed on at least one surface of the base, wherein the toner fixation layer includes an inorganic filler and a binder, wherein the inorganic filler includes at least two materials each having a volume average particle diameter different from each other is provided.

Descriptions of the base and the inorganic filler and binder of the toner fixation layer are the same as described above.

When the inorganic filler including at least two materials each having a volume average particle diameter different from each other is used, the materials having smaller volume average particle diameter are filled into pores of the materials having larger volume average particle diameter. Thus, a density of a coating layer increases, and due to a filling effect, smoothness and gloss properties of paper are improved at the same temperature and pressure during calendaring. Therefore, when the inorganic filler including at least two materials each having a volume average particle diameter different from each other is used, manufacturing costs can be reduced, manufacturing process problems can be resolved and an electrophotographic recording medium with excellent smoothness and gloss properties can be prepared. Consequently, such properties of the electrophotographic recording medium positively affect gloss properties after printing.

The inorganic filler may include a material having a small volume average particle diameter of 0.01 to 0.5 μm and a material having a large volume average particle diameter of 1 to 2 μm.

An amount ratio of the material having the small volume average particle diameter to the material having the large volume average particle diameter may be in a range of 95:5 to 50:50, such as in a range of 90:10 to 60:40. When the amount of the material having the small volume average particle diameter is greater than 95 wt % based on the total weight of the inorganic filler, that is, when the amount of the material having the small volume average particle diameter is too much, an effect of adding at least two materials each having a volume average particle diameter different from each other is insignificant. Alternatively, when the amount of the material having the small volume average particle diameter is less than 50 wt % based on the total weight of the inorganic filler, that is, when the amount of the material having the large volume average particle diameter is too much, smoothness and gloss properties of the electrophotographic recording medium are deteriorated.

In the electrophotographic recording medium according to the current embodiment of the present general inventive concept, the toner fixation layer is prepared by coating a composition to form a toner fixation layer on the base and drying the composition.

The composition to form the toner fixation layer may include 5 to 100 parts by weight of the binder based on 100 parts by weight of the filler. The filler is an inorganic filler as described above, and the amount ratio of the material having the small volume average particle diameter to the material having the large volume average particle diameter may be in a range of 95:5 to 50:50.

According to an embodiment of the present general inventive concept, in the electrophotographic recording medium including the toner fixation layer including an inorganic filler including at least two materials each having a volume average particle diameter different from each other, the toner fixation layer is prepared by coating the composition to form the toner fixation layer on one or both surface of the base and then drying the composition, as described above. The thickness of the toner fixation layer prepared in the process described above may be in a range of about 5 to about 40 μm, such as in a range of 10 to 30 μm. When the thickness of the toner fixation layer is less than 5 μm, the toner fixation layer can not function properly. Alternatively, when the thickness of the toner fixation layer is greater than 40 μm, raw material costs are high and the composition to form the toner fixation layer can not be dried when being coated. Descriptions of a method of preparing the electrophotographic recording medium according to the current embodiment of the present general inventive concept are the same as described above.

Hereinafter, the present general inventive concept will be described more specifically with reference to the following examples. The following examples are for illustrative purposes only and are not intended to limit the scope of the general inventive concept.

### EXAMPLE 1

A composition to form a toner fixation layer was as follows.

| | |
|---|---|
| Polyvinyl alcohol (F-05, DC chemical, Korea) | 2 parts by weight |
| Acryl-based latex (SAV-4720, Sinature, Korea | 8 parts by weight |
| Calcium carbonate (SETACARB HG, 0.4 μm, | 89.5 parts by weight |
| OMIYA, Korea) | |
| Boric acid (Junsei, Japan) | 0.5 parts by weight |
| Water | 100 parts by weight |

The prepared composition to form a toner fixation layer was coated on raw art paper (Hansol paper, Korea) having a basis weight of 140 g/m² using a bar coater, and then the composition was dried in an oven at 110° C. for 3 minutes to form a toner fixation layer having a basis weight of about 20 g/m². Then, calendaring was performed on the composition at a temperature of 60° C. and a pressure of 500 psi using a 753 super calendar device available from Beloit Wheeler company to prepare an electrophotographic recording medium.

### EXAMPLE 2

An electrophotographic recording medium was prepared in the same manner as in Example 1, except that the composition to form the toner fixation layer was as follows.

| | |
|---|---|
| Polyvinyl alcohol (F-05, DC chemical, Korea) | 2 parts by weight |
| Acryl-based latex (SAV-4720, Sinature, Korea) | 8 parts by weight |
| Calcium carbonate (SETACARB HG, 0.4 μm, | 88 parts by weight |
| OMIYA, Korea) | |
| Boric acid (Junsei, Japan) | 2 parts by weight |
| Water | 100 parts by weight |

### EXAMPLE 3

An electrophotographic recording medium was prepared in the same manner as in Example 1, except that the composition to form the toner fixation layer was as follows.

| | |
|---|---|
| Polyvinyl alcohol (F-05, DC chemical, Korea) | 2 parts by weight |
| Acryl-based latex (SAV-4720, Sinature, Korea) | 8 parts by weight |
| Calcium carbonate (SETACARB HG, 0.4 μm, | 88 parts by weight |
| OMIYA, Korea) | |
| Glyoxal (BASF, Korea) | 2 parts by weight |
| Water | 100 parts by weight |

### EXAMPLE 4

An electrophotographic recording medium was prepared in the same manner as in Example 1, except that the composition to form the toner fixation layer was as follows.

| | |
|---|---|
| Polyvinyl alcohol (F-05, DC chemical, Korea) | 2 parts by weight |
| Acryl-based latex (SAV-4720, Sinature, Korea) | 8 parts by weight |
| Calcium carbonate (SETACARB HG, 0.4 μm, | 88 parts by weight |
| OMIYA, Korea) | |
| Silane coupling agent (LD5501, Damipoly, | 2 parts by weight |
| Korea) | |
| Water | 100 parts by weight |

### COMPARATIVE EXAMPLE 1

An electrophotographic recording medium was prepared in the same manner as in Example 1, except that the composition to form the toner fixation layer was as follows.

| | | |
|---|---|---|
| Polyvinyl alcohol (F-05, DC chemical, Korea) | 2 | parts by weight |
| Acryl-based latex (SAV-4720, Sinature, Korea) | 8 | parts by weight |
| Calcium carbonate (SETACARB HG, 0.4 μm, | 90 | parts by weight |
| OMIYA, Korea) | | |
| Water | 100 | parts by weight |

### COMPARATIVE EXAMPLE 2

An electrophotographic recording medium was prepared in the same manner as in Example 1, except that the composition to form the toner fixation layer was as follows.

| | | |
|---|---|---|
| Polyvinyl alcohol (F-05, DC chemical, Korea) | 2 | parts by weight |
| Acryl-based latex (SAV-4720, Sinature, Korea) | 8 | parts by weight |
| Calcium carbonate (SETACARB HG, 0.4 μm, | 90 | parts by weight |
| OMIYA, Korea) | | |
| Boric acid (Junsei, Japan) | 0.05 | parts by weight |
| Water | 100 | parts by weight |

### COMPARATIVE EXAMPLE 3

An electrophotographic recording medium was prepared in the same manner as in Example 1, except that the composition to form the toner fixation layer was as follows.

| | | |
|---|---|---|
| Polyvinyl alcohol (F-05, DC chemical, Korea) | 2 | parts by weight |
| Acryl-based latex (SAV-4720, Sinature, Korea) | 8 | parts by weight |
| Calcium carbonate (SETACARB HG, 0.4 μm, | 83 | parts by weight |
| OMIYA, Korea) | | |
| Glyoxal (BASF, Korea) | 7 | parts by weight |
| Water | 100 | parts by weight |

### COMPARATIVE EXAMPLE 4

An electrophotographic recording medium was prepared in the same manner as in Example 1, except that the composition to form the toner fixation layer was as follows.

| | | |
|---|---|---|
| Polyvinyl alcohol (F-05, DC chemical, Korea) | 2 | parts by weight |
| Acryl-based latex (SAV-4720, Sinature, Korea) | 8 | parts by weight |
| Calcium carbonate (SETACARB HG, 0.4 μm, | 83 | parts by weight |
| OMIYA, Korea) | | |
| Silane coupling agent (LD5501, Damipoly, | 7 | parts by weight |
| Korea) | | |
| Water | 100 | parts by weight |

Smoothness, gloss properties and a breakage degree of a coating layer of each of the electrophotographic recording media prepared in Examples 1 through 4 and Comparative Examples 1 through 4 are illustrated in Table 1 below.

TABLE 1

| | | Gloss properties | | Breakage degree |
|---|---|---|---|---|
| | smoothness | 60° | 85° | of coating layer |
| Example 1 | 0.80 μm | 42 | 72 | ⊚ |
| Example 2 | 0.75 μm | 45 | 75 | ◯ |
| Example 3 | 0.80 μm | 40 | 73 | ◯ |
| Example 4 | 0.70 μm | 45 | 76 | ◯ |
| Comparative | 0.85 μm | 35 | 65 | ⊚ |
| Example 1 | | | | |
| Comparative | 0.85 μm | 33 | 62 | ◯ |
| Example 2 | | | | |
| Comparative | 0.75 μm | 46 | 77 | X |
| Example 3 | | | | |
| Comparative | 0.80 μm | 49 | 79 | X |
| Example 4 | | | | |

*Smoothness was measured using a TR-100 manufactured by TIMES; the lower the value, the better the smoothness.
*Gloss properties were measured using a Microgloss Ref-160 manufactured by Sheen; the higher the value, the better the gloss properties.
*Breakage degree of coating layer was measured as follows: coated paper was folded in half, and then unfolded to original position, a tape was stuck on the folded part and then a degree by which the coated layer was removed by the tape was relatively compared (◯: good, ⊚: very little, X: high)

Printing gloss and optical density of each of the electrophotographic recording media prepared in Examples 1 through 4 and Comparative Examples 1 through 4 are illustrated in Table 2 below.

TABLE 2

| | |
|---|---|
| Printing Gloss | Optical Density |

| | 60° | 85° | Magenta | Black |
|---|---|---|---|---|
| Example 1 | 19 | 57 | 1.01 | 1.69 |
| Example 2 | 24 | 64 | 1.05 | 1.73 |
| Example 3 | 22 | 60 | 1.01 | 1.72 |
| Example 4 | 26 | 68 | 1.06 | 1.76 |
| Comparative | 15 | 49 | 1.00 | 1.65 |
| Example 1 | | | | |
| Comparative | 14 | 48 | 1.01 | 1.64 |
| Example 2 | | | | |
| Comparative | 20 | 60 | 1.03 | 1.73 |
| Example 3 | | | | |
| Comparative | 24 | 63 | 1.02 | 1.75 |
| Example 4 | | | | |

*Printing Gloss: A black block was printed on the coated paper using a laser printer color Laserjet 2600 manufactured by HP, and then printing gloss of the printed black block was measured using a Microgloss Ref-160 manufactured by Sheen; the higher the value, the better the printing gloss.
*Optical density: Magenta and black images were printed using the same printer used in the measurement of the printing gloss, and then optical densities of the images were measured using a Spectroeye manufactured by GretagMacbeth, US as an optical density measuring device; the higher the value, the better the clearness of the images.

Referring to Table 1 illustrating the smoothness and gloss properties of the electrophotographic recording media prepared in Examples 1 through 4 and Comparative Examples 1 through 4, the toner fixation layer including a certain amount of the surface hardener exhibited excellent smoothness and gloss properties. However, in the case of the electrophotographic recording media prepared in Comparative Examples 3 and 4, when the amount of the surface hardener used was greater than 5 parts by weight based on 100 parts by weight of the filler, the smoothness and gloss properties increased, but the coated layer was broken. Therefore, to prepare an electrophotographic recording medium with high smoothness and high gloss under the same calendaring conditions, the toner fixation layer should include the surface hardener within appropriate ranges of amounts.

From the results illustrated in Table 2, in the case of the toner fixation layer including the surface hardener, high printing gloss and clear images could be obtained, compared to the case of the toner fixation layer that did not include the surface hardener.

### EXAMPLE 5

An electrophotographic recording medium was prepared in the same manner as in Example 1, except that the composition to form the toner fixation layer was as follows.

| | | |
|---|---|---|
| Polyvinyl alcohol (F-05, DC chemical, Korea) | 2 | parts by weight |
| Acryl-based latex (SAV-4720, Sinature, Korea) | 8 | parts by weight |
| Calcium carbonate (COVERCARB 75, 0.5 μm, | 80 | parts by weight |
| OMIYA, Korea) | | |
| Calcium carbonate (HYDROCARB 60K, 1.4 μm, | 10 | parts by weight |
| OMIYA, Korea) | | |
| Water | 100 | parts by weight |

### EXAMPLE 6

An electrophotographic recording medium was prepared in the same manner as in Example 1, except that the composition to form the toner fixation layer was as follows.

| | | |
|---|---|---|
| Polyvinyl alcohol (F-05, DC chemical, Korea) | 2 | parts by weight |
| Acryl-based latex (SAV-4720, Sinature, Korea) | 8 | parts by weight |
| Calcium carbonate (SETACARB HG, 0.4 μm, | 70 | parts by weight |
| OMIYA, Korea) | | |
| Calcium carbonate (HYDROCARB 75F, 1.1 μm, | 20 | parts by weight |
| OMIYA, Korea) | | |
| Water | 100 | parts by weight |

### EXAMPLE 7

An electrophotographic recording medium was prepared in the same manner as in Example 1, except that the composition to form the toner fixation layer was as follows.

| | | |
|---|---|---|
| Polyvinyl alcohol (F-05, DC chemical, Korea) | 2 | parts by weight |
| Acryl-based latex (SAV-4720, Sinature, Korea) | 8 | parts by weight |
| Calcium carbonate (SETACARB K, 0.45 μm, | 70 | parts by weight |
| OMIYA, Korea) | | |
| Calcium carbonate (OKYUMHWA TL-3000, | 20 | parts by weight |
| 1.5 μm, OMIYA, Korea) | | |
| Water | 100 | parts by weight |

### COMPARATIVE EXAMPLE 5

An electrophotographic recording medium was prepared in the same manner as in Example 1, except that the composition to form the toner fixation layer was as follows.

| | | |
|---|---|---|
| Polyvinyl alcohol (F-05, DC chemical, Korea) | 2 | parts by weight |
| Acryl-based latex (SAV-4720, Sinature, Korea) | 8 | parts by weight |
| Calcium carbonate (SETACARB K, 0.45 μm, | 90 | parts by weight |
| OMIYA, Korea) | | |
| Water | 100 | parts by weight |

### COMPARATIVE EXAMPLE 6

An electrophotographic recording medium was prepared in the same manner as in Example 1, except that the composition to form the toner fixation layer was as follows.

| | | |
|---|---|---|
| Polyvinyl alcohol (F-05, DC chemical, Korea) | 2 | parts by weight |
| Acryl-based latex (SAV-4720, Sinature, Korea) | 8 | parts by weight |
| Calcium carbonate (SETACARB 60K, 1.4 μm, | 90 | parts by weight |
| OMIYA, Korea) | | |
| Water | 100 | parts by weight |

### COMPARATIVE EXAMPLE 7

An electrophotographic recording medium was prepared in the same manner as in Example 1, except that the composition to form the toner fixation layer was as follows.

| | | |
|---|---|---|
| Polyvinyl alcohol (F-05, DC chemical, Korea) | 2 | parts by weight |
| Acryl-based latex (SAV-4720, Sinature, Korea) | 8 | parts by weight |
| Calcium carbonate (OM-5, 4.4 μm, OMIYA, | 90 | parts by weight |
| Korea) | | |
| Water | 100 | parts by weight |

### COMPARATIVE EXAMPLE 8

An electrophotographic recording medium was prepared in the same manner as in Example 1, except that the composition to form the toner fixation layer was as follows.

| | | |
|---|---|---|
| Polyvinyl alcohol (F-05, DC chemical, Korea) | 2 | parts by weight |
| Acryl-based latex (SAV-4720, Sinature, Korea) | 8 | parts by weight |
| Calcium carbonate (COVERCARB 75, 0.6 μm, | 30 | parts by weight |
| OMIYA, Korea) | | |
| Calcium carbonate (HYDROCARB 60K, 1.4 μm, | 50 | parts by weight |
| OMIYA, Korea) | | |
| Water | 100 | parts by weight |

Smoothness and gloss properties of each of the electrophotographic recording media prepared in Examples 5 through 7 and Comparative Examples 5 through 8 were measured as described above. The results are illustrated in Table 3 below.

TABLE 3

Gloss properties

| | Smoothness | 60° | 85° |
|---|---|---|---|
| Example 5 | 0.80 μm | 42 | 71 |
| Example 6 | 0.75 μm | 42 | 75 |
| Example 7 | 0.80 μm | 39 | 68 |
| Comparative | 0.85 μm | 38 | 64 |
| Example 5 | | | |
| Comparative | 1.45 μm | 24 | 54 |
| Example 6 | | | |
| Comparative | 2.00 μm | 15 | 41 |
| Example 7 | | | |
| Comparative | 1.25 μm | 21 | 50 |
| Example 8 | | | |

Printing gloss and optical density of each of the electrophotographic recording media prepared in Examples 5 through 7 and Comparative Examples 5 through 8 were measured as described above, and the results are illustrated in Table 4 below.

TABLE 4

| | |
|---|---|
| Printing Gloss | Optical Density |

| | 60° | 85° | Magenta | Black |
|---|---|---|---|---|
| Example 5 | 20 | 60 | 1.02 | 1.71 |
| Example 6 | 22 | 65 | 1.04 | 1.72 |
| Example 7 | 20 | 59 | 1.00 | 1.69 |
| Comparative | 17 | 55 | 1.00 | 1.65 |
| Example 5 | | | | |
| Comparative | 10 | 36 | 0.89 | 1.51 |
| Example 6 | | | | |
| Comparative | 5 | 26 | 0.88 | 1.45 |
| Example 7 | | | | |
| Comparative | 12 | 40 | 0.94 | 1.57 |
| Example 8 | | | | |

Referring to Table 3 illustrating smoothness and gloss properties of the electrophotographic recording media prepared in Examples 5 through 7 and Comparative Examples 5 through 8, the toner fixation layer including two inorganic fillers each having a volume average particle diameter different from each other exhibited excellent smoothness and gloss properties, compared to the toner fixation layer including the inorganic fillers having the same volume average particle diameter.

In addition, from the results illustrated in Table 4, in the case of the toner fixation layer including the two inorganic fillers each having a volume average particle diameter different from each other, high printing gloss and clear images were obtained. However, although the two inorganic fillers each having a volume average particle diameter different from each other were used, gloss properties, as in the electrophotographic recording medium of Comparative Example 8 were reduced when the amount of the inorganic filler having a large volume average particle diameter, that is, a large particle diameter inorganic filler is relatively larger than the amount of the inorganic filler having a small volume average particle diameter. Thus, the amount ratio of the two inorganic fillers each having a volume average particle diameter different from each other should be appropriately adjusted.

According to the above embodiments, when a certain amount of the surface hardener or an inorganic filler including at least two materials each having a volume average particle diameter different from each other is included in the toner fixation layer, an electrophotographic recording medium that has excellent smoothness and gloss properties, has high printing gloss after printing, and provides clear images can be prepared.

While the present general inventive concept has been particularly illustrated and described with reference to exemplary embodiments thereof, it will be understood by those of ordinary skill in the art that various changes in form and details may be made therein without departing from the spirit and scope of the present general inventive concept as defined by the following claims.

What is claimed is:

1. An electrophotographic recording medium, comprising:
a base; and
a toner fixation layer formed on at least one surface of the base,
wherein the toner fixation layer comprises a filler, a binder, and a surface hardener.

2. The electrophotographic recording medium of claim 1, wherein the toner fixation layer comprises:
5 to 100 parts by weight of the binder, and 0.1 to 5 parts by weight of the surface hardener, based on 100 parts by weight of the filler.

3. The electrophotographic recording medium of claim 1, wherein the surface hardener comprises:
at least one selected from the group consisting of a water-soluble curing agent, a siloxane-based surfactant, and a silane coupling agent.

4. The electrophotographic recording medium of claim 1, wherein the base comprises one selected from the group consisting of synthetic paper, woodfree paper, art paper, coated paper, mixed paper, baryta paper, impregnated paper, paperboard, cellulose tissue paper, a transparent or semi-transparent plastic film selected from polyolefin, polyvinyl chloride, polyethylene terephthalate, polystyrene, polymethacrylate, or polycarbonate, and a foamed sheet, or comprises a combination of two or more layers selected therefrom, in a form of a laminated structure.

5. The electrophotographic recording medium of claim 1, wherein a thickness of the base is in a range of 50 to 300 μm.

6. The electrophotographic recording medium of claim 1, wherein the filler comprises:
an inorganic filler selected from the group consisting of kaolin clay, silica, calcium carbonate, talc, aluminum hydroxide, satin white, titanium dioxide, calcined clay, zinc oxide, and barium sulfate, or an organic filler selected from the group consisting of a styrene-based resin, an acryl-based resin, polyvinyl chloride, and polycarbonate.

7. The electrophotographic recording medium of claim 1, wherein the binder comprises at least one selected from the group consisting of polyvinyl alcohol, polyvinyl pyrolidone, methyl cellulose, hydroxypropylmethyl cellulose, gelatin, polyethylene oxide, an acryl-based polymer, polyester, polyurethane, an epoxy resin, latex, and a quaternary ammonium-based copolymer.

8. The electrophotographic recording medium of claim 1, wherein the toner fixation layer further comprises:
an additive.

9. The electrophotographic recording medium of claim 1, wherein a thickness of the toner fixation layer is in a range of 5 to 40 μm.

10. The electrophotographic recording medium of claim 1, wherein the toner fixation layer is formed on both surfaces of the base.

11. An electrophotographic recording medium, comprising:
a base; and
a toner fixation layer formed on at least one surface of the base, the toner fixation layer comprises an inorganic filler and a binder,
wherein the inorganic filler comprises at least two materials each having a volume average particle diameter different from each other.

12. The electrophotographic recording medium of claim 11, wherein the inorganic filler comprises:
a material having a small volume average particle diameter of 0.01 to 0.5 μm and a material having a large volume average particle diameter of 1 to 2 μm.

13. The electrophotographic recording medium of claim 12, wherein an amount ratio of the material having the small volume average particle diameter to the material having the large volume average particle diameter is in a range of 95:5 to 50:50.

14. A composition to form a toner fixation layer, the composition comprising:
a filler;
a binder; and
a surface hardener.

15. The composition of claim 14, comprising:
5 to 100 parts by weight of the binder and 0.1 to 5 parts by weight of the surface hardener, based on 100 parts by weight of the filler.

16. The composition of claim 14, wherein the solvent comprises:
at least one selected from the group consisting of water, ketones, glycol ethers, alcohols, methylcellosolve, ethylcellosolve, dimethyl formamide, and dimethyl sulfoxide.
